(19) United States
(12) Patent Application Publication
(10) Pub. No.: US 2015/0008894 A1
(43) Pub. Date: Jan. 8, 2015

(54) DYNAMIC START-UP CIRCUIT FOR HYSTERETIC LOOP SWITCHED-CAPACITOR VOLTAGE REGULATOR

(71) Applicant: LSI Corporation, San Jose, CA (US)

(72) Inventors: Naveen K.V.M. Cannankurichi, Bangalore (IN); Ankuj Keshwani, Madhya Pradesh (IN); Ricky F. Bitting, Fort Collins, CO (US); Saumen Mondal, Gaya (IN)

(73) Assignee: LSI Corporation, San Jose, CA (US)

(21) Appl. No.: 14/226,107

(22) Filed: Mar. 26, 2014

(30) Foreign Application Priority Data
Jul. 2, 2013 (IN) 2938/CHE/2013

(51) Int. Cl. H02M 1/36; H02M 3/156

(52) U.S. Cl. CPC H02M 1/36; H02M 3/156
USPC 323/282

(57) ABSTRACT

A startup circuit for use with a SCVR circuit includes a comparator operative to generate a first control signal as a function of a comparison between an output voltage generated by the SCVR circuit and a reference voltage, the first control signal being used to disable the startup circuit. The startup circuit further includes a reference generator and a controller. The reference generator is coupled with the comparator and operative to generate at least first, second and third voltages, the second voltage being greater than the first voltage, and the third voltage being greater than the second voltage. The controller is coupled with the reference generator and operative to dynamically select a given one of the first and third voltages as the reference voltage supplied to the comparator as a function of the first control signal.

### CROSS-REFERENCE TO RELATED APPLICATIONS

This application claims priority under 35 U.S.C. §119 from Indian Patent Application No. 2938/CHE/2013 filed in the Indian Patent Office on Jul. 2, 2013, the disclosure of which is incorporated herein by reference in its entirety.

### FIELD OF INVENTION

The present invention relates generally to electrical and electronic circuitry, and more particularly relates to start-up circuitry in a switched-capacitor voltage regulator.

### BACKGROUND

Voltage regulation is widely used in electronic circuits and systems for maintaining an output voltage at a prescribed level (or within a prescribed range) despite variations in an input voltage supplied to the regulator. One of the simplest forms of voltage regulation employs a hysteretic control mechanism, also known as a “bang-bang” controller, which switches abruptly between two states (e.g., on and off). More particularly, a hysteretic voltage regulator simply turns a switch on when the output voltage is below a prescribed reference level, to thereby allow the output voltage to rise, and turns the switch off when the output rises above this reference level, to thereby allow the output voltage to fall.

Switched-capacitor voltage regulators (SCVRs) are well known in the art. Switched-capacitor voltage regulators are well-suited for monolithic integration since they provide a means for eliminating inductors which are difficult to fabricate on-chip without the use of costly integrated circuit (IC) processing steps. Switched-capacitor voltage regulators require clock circuitry to generate an internal clock signal to control the voltage regulation operation.

In order to improve the performance of voltage regulators (e.g., increasing power supply rejection ratio (PSRR)), internal bias circuitry used to generate the reference voltage, as well as other functional circuitry (e.g., comparator) in the voltage regulator, are often powered directly from the regulated output voltage; this circuit architecture is often referred to as a self-powered configuration. As such, one or more of these functional circuits may not be self-starting when power is first applied to the voltage regulator or when the regulator output is momentarily shorted to ground. Consequently, many voltage regulators employ start-up circuitry to initiate a flow of current in the regulator during an initial power-on period.

Start-up circuitry undesirably increases power consumption in the voltage regulator and may also interfere with the normal operation of the regulator. Accordingly, various techniques for turning off the start-up circuitry once the regulator output has reached a sustainable level have been proposed. These conventional approaches, however, have drawbacks associated therewith, including, but not limited to, increased complexity, increased chip area and decreased reliability.

### SUMMARY

In accordance with an embodiment of the invention, a startup circuit for use with a SCVR circuit includes a comparator operative to generate a first control signal as a function of a comparison between an output voltage generated by the SCVR circuit and a reference voltage, the first control signal being used to disable the startup circuit. The startup circuit further includes a reference generator and a controller. The reference generator is coupled with the comparator and operative to generate at least first, second and third voltages, the second voltage being greater than the first voltage, and the third voltage being greater than the second voltage. The controller is coupled with the reference generator and operative to dynamically select a given one of the first and third voltages as the reference voltage supplied to the comparator as a function of the first control signal.

In accordance with another embodiment of the invention, an SCVR circuit includes at least a first comparator, a clock generator, and a switched-capacitor circuit. The first comparator is operative to receive a first input signal indicative of a regulated output signal of the voltage regulator circuit and a second input signal indicative of a first reference signal, and to generate an output signal indicative of a comparison result between the first and second input signals. The clock generator is operative to receive the output signal generated by the first comparator and to generate a plurality of clock signals. The switched-capacitor circuit is operative to receive the plurality of clock signals and to generate, at an output of the SCVR circuit, the regulated output signal as a function of the plurality of clock signals. The SCVR circuit further includes a startup circuit coupled with at least one node in the voltage regulator circuit and operative to maintain a flow of current in the voltage regulator circuit. The startup circuit includes a second comparator operative to generate a first control signal as a function of a comparison between the regulated output signal and a second reference signal, the first control signal being used to disable the startup circuit. The startup circuit further includes a reference generator and a controller. The reference generator is coupled with the second comparator and operative to generate at least first, second and third voltages, the second voltage being greater than the first voltage, and the third voltage being greater than the second voltage. The controller is coupled with the reference generator and operative to dynamically select a given one of the first and third voltages as the second reference signal supplied to the second comparator as a function of the first control signal.

Embodiments of the invention will become apparent from the following detailed description thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIGS. 1A and 1B conceptually depict at least a portion of an exemplary switch cell of an SCVR circuit and illustrative signal waveforms corresponding thereto;

FIG. 2 is a schematic diagram depicting at least a portion of an illustrative hysteretic loop LBC control SCVR circuit in which embodiments of the invention can be implemented;

FIG. 3 is a schematic diagram depicting at least a portion of an exemplary clock generator circuit which can be utilized in the SCVR circuit shown in FIG. 2;

FIG. 4 is a schematic diagram depicting at least a portion of an exemplary startup circuit suitable for use in an SCVR circuit, according to an embodiment of the invention;

FIG. 5 is a schematic diagram depicting at least a portion of an exemplary amplifier circuit suitable for use in the reference circuit shown in FIG. 4, according to an embodiment of the invention;

FIG. 6 is a schematic diagram depicting at least a portion of an exemplary hysteretic comparator circuit suitable for use in the illustrative SCVR circuit shown in FIG. 2, according to an embodiment of the invention; and

FIG. 7 depicts exemplary waveforms for prescribed signals in the illustrative startup circuit shown in FIG. 4, according to an embodiment of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Embodiments of the invention will be described herein in the context of illustrative switched-capacitor voltage regulator (SCVR) circuits and start-up circuitry used in the SCVR circuits for initiating and, when necessary, maintaining a flow of current in the regulator independent of output conditions. It should be understood, however, that embodiments of the invention are not limited to these or any other particular circuits. Rather, embodiments of the invention are more broadly related to techniques for dynamically controlling the activation of start-up circuitry used in voltage regulator (e.g., SCVR) and/or voltage converter (e.g., DC-DC converter) circuits. Moreover, it will become apparent to those skilled in the art given the teachings herein that numerous modifications can be made to the embodiments shown that are within the scope of the claimed invention. That is, no limitations with respect to the embodiments shown and described herein are intended or should be inferred.

As a preliminary matter, for the purposes of clarifying and describing embodiments of the invention, the following table provides a summary of certain acronyms and their corresponding definitions, as the terms are used herein:

Table of Acronym Definitions

| Acronym | Definition |
|---|---|
| SCVR | Switched-capacitor voltage regulator |
| IC | Integrated circuit |
| PSRR | Power supply rejection ratio |
| MISFET | Metal-insulator-semiconductor field-effect transistor |
| MOSFET | Metal-oxide-semiconductor field-effect transistor |
| NFET | N-channel field-effect transistor |
| NMOS | N-channel metal-oxide-semiconductor |
| PFET | P-channel field-effect transistor |
| PMOS | P-channel metal-oxide-semiconductor |
| CMOS | Complementary metal-oxide-semiconductor |
| BJT | Bipolar junction transistor |
| MOS | Metal-oxide-semiconductor |
| SoC | System-on-chip |
| SPST | Single-pole, single-throw |
| LBC | Lower boundary control |
| SC | Switched-capacitor |

Throughout the description herein, the term MISFET is intended to be construed broadly and to encompass any type of metal-insulator-semiconductor field-effect transistor. The term MISFET is, for example, intended to encompass semiconductor field-effect transistors that utilize an oxide material as their gate dielectric (i.e., metal-oxide-semiconductor field-effect transistors (MOSFETs)), as well as those that do not. In addition, despite a reference to the term “metal” in the acronym MISFET, the term MISFET is also intended to encompass semiconductor field-effect transistors wherein the gate is formed from a non-metal, such as, for instance, polysilicon.

Although embodiments of the invention described herein may be implemented using p-channel MISFETs (hereinafter called “PFETs” or “PMOS” devices) and/or n-channel MISFETs (hereinafter called “NFETs” or “NMOS” devices), as may be formed using a complementary metal-oxide-semiconductor (CMOS) fabrication process, it is to be appreciated that embodiments of the invention are not limited to such transistor devices and/or such a fabrication process, and that other suitable devices, such as, for example, bipolar junction transistors (BJTs), FinFETs, etc., and/or fabrication processes (e.g., bipolar, BiCMOS, etc.), may be similarly employed, as will be understood by those skilled in the art. Moreover, although embodiments of the invention are typically fabricated in a silicon wafer, embodiments of the invention can alternatively be fabricated in wafers comprising other materials, including but not limited to gallium arsenide (GaAs), indium phosphide (InP), etc.

Voltage scaling and multiple voltage domains have been used in high-performance systems as a means for reducing overall power consumption. Specifically, power consumption in a system-on-chip (SoC) can be substantially reduced by providing multiple supply rails having output voltages optimized to the corresponding subsystems to which they are coupled. With the introduction of the SCVR, it is possible to integrate voltage regulation directly with its corresponding subsystem.

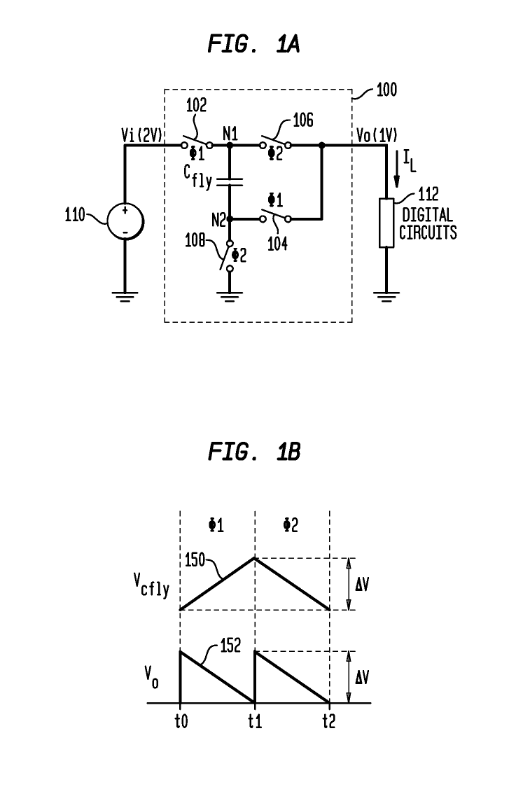

FIGS. 1A and 1B conceptually depict at least a portion of an exemplary switch cell 100, suitable for use, for example, in a hysteric loop SCVR circuit, and illustrative signal waveforms corresponding thereto. It is to be appreciated that an SCVR circuit, particularly a hysteretic-controlled regulator, may employ more than one switch cell 100. Hysteretic control maintains the regulator output voltage within a hysteretic band centered about a prescribed reference voltage. A hysteretic-controlled regulator offers fast load transient response and eliminates the need for feedback-loop compensation.

With specific reference to FIG. 1A, the switch cell 100 comprises a charge-transferring element which, in this embodiment, is implemented in the form of a storage capacitor, C_{fly}, and four switches, each depicted symbolically in a single-pole, single-throw (SPST) representation. A first terminal of a first switch 102 forms an input of the switch cell 100 adapted to receive an input signal, Vi, a second terminal of the first switch is connected with a first terminal of the storage capacitor C_{fly} at a first node N1, a second terminal of capacitor C_{fly} is connected with a first terminal of a second switch 104 at a second node N2, a second terminal of the second switch is connected with a first terminal of a third switch 106 and forms an output of the SCVR circuit 100 adapted to generate an output signal, Vo, a second terminal of the third switch is connected with node N1, a first terminal of a fourth switch 108 is connected with node N2, and a second terminal of the fourth switch is adapted for connection with ground, or an alternative voltage source. The input signal Vi supplied to the input of the switch cell 100, which in this embodiment is about two volts, is generated by a signal source, which is modeled as an ideal voltage source 110. The output signal Vo, which in this embodiment is about one volt, generated by the switch cell 100 is provided to circuitry (e.g., digital circuits) 112 connected with the output of the switch cell. It is to be understood that embodiments of the invention are not limited to any specific input or output voltages.

The illustrative switch cell 100 operates in a two-phase clock cycle, Φ1 and Φ2, with one pair of switches, 102 and 104, being activated during a first phase, Φ1, and another pair of switches, 106 and 108, being activated during a second phase, Φ2. The two pairs of switches are not active concurrently. During the first phase Φ1, the storage capacitor C_{fly} is connected in series between the input and the output of the switch cell 100. During the second phase Φ2, the storage capacitor C_{fly} is connected between the output of the switch cell 100 and ground. Thus, phase Φ1 is a charge portion of the cycle, and phase Φ2 is a discharge portion of the cycle. By switching between these two configurations, charge is transferred from the input to the output of the SCVR circuit 100. A load current, I_{L}, generated by the SCVR circuit 100 will have a magnitude that is a function of the output voltage Vo generated by the SCVR circuit and an impedance of the circuitry 112, which in this embodiment comprises digital circuits, connected with the SCVR circuit.

FIG. 1B depicts illustrative signal waveforms corresponding to the exemplary switch cell 100 shown in FIG. 1A. Specifically, a first waveform 150 is representative of a voltage, V_{Cfly}, across the storage capacitor C_{fly} in the switch cell 100, and a second waveform 152 is representative of the output voltage Vo of the switch cell. During the first phase Φ1, from time t0 to t1, switches 102 and 104 are turned on and switches 106 and 108 are turned off, allowing the capacitor C_{fly} to charge. The voltage across the capacitor voltage V_{Cfly} will increase during phase Φ1 according to the expression:

V_{Cfly}=Vᵢ(1−e^{-t/τ}),

where t is the elapsed time since application of the input voltage Vi, and τ is the time constant of the circuit (τ=RC). The difference between the voltage at the start of phase Φ1 (t0) and the voltage at the end of Φ1 (t1) is ΔV. During the same period, from time t0 to t1, the output voltage Vo of the switch cell 100 will jump at time t0 and then discharge at the same rate as capacitor C_{fly} charges. During the second phase Φ2, from time t1 to t2, switches 102 and 104 are turned off and switches 106 and 108 are turned on, allowing the voltage V_{Cfly} across the capacitor C_{fly} to discharge by ΔV. The output voltage Vo during phase Φ2 will be the same as the voltage V_{Cfly} across the capacitor C_{fly}.

FIGS. 1A and 1B thus provide a very broad conceptual overview of an illustrative switch cell (i.e., switched capacitor unit). In practice, there will be multiple switched capacitor units controlled by multiple clock phases (e.g., three or four capacitor elements and ten to fifteen corresponding switches interconnecting these capacitors in two phases). While embodiments of the invention are not limited to any specific switched capacitor architecture, in the two-phase example shown in FIG. 1A, it will be apparent to those skilled in the art that charge transfer will occur between phase Φ1 and phase Φ2 from the capacitor element.

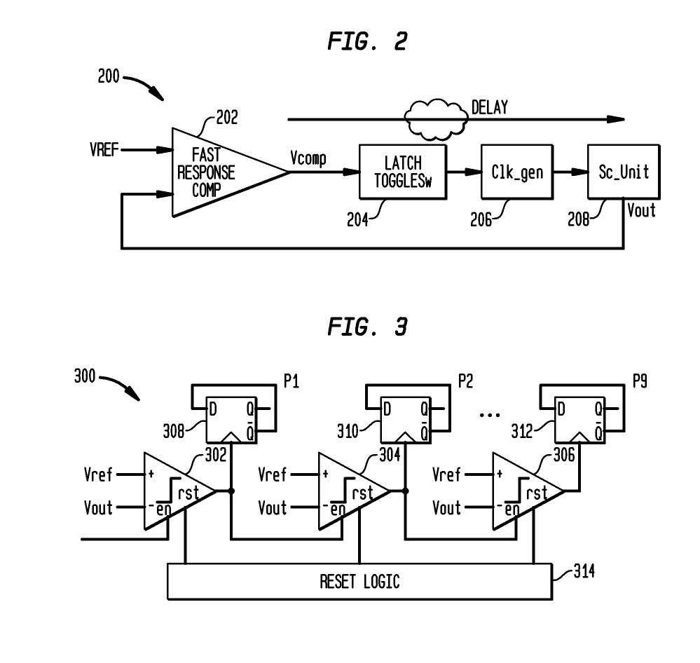

FIG. 2 is a schematic diagram depicting at least a portion of an illustrative hysteretic loop lower boundary control (LBC) SCVR circuit 200 in which embodiments of the invention can be implemented. The SCVR circuit 200 includes a comparator 202, a latch circuit 204 connected with the comparator, a clock generator (Clk_gen) 206, and a switched-capacitor circuit (Sc_Unit) 208. The switched-capacitor circuit 208 may be formed in a manner consistent with the switch cell 100 shown in FIG. 1A, although embodiments of the invention are not limited to any specific switched-capacitor circuit architecture.

The comparator 202, which is preferably a fast response comparator (e.g., about 1 GHz), is operative to generate a compare signal, Vcomp, indicative of a comparison between a reference signal, Vref, supplied to the comparator and an output signal, Vout, of the SCVR circuit 200. The latch circuit 204 is operative to hold (i.e., latch) the output of the comparator 202 for a prescribed period of time. This latched comparator output is supplied as an input to the clock generator 206, which is operative to generate one or more clock signals as a function of the comparison result. In one embodiment, the clock generator 206 is operative to generate multiple clock phase signals for use by the switched-capacitor circuit 208.

The switched-capacitor circuit 208 utilizes the multiple clock phase signals supplied by the clock generator 206 for controlling switches in the switched-capacitor circuit during various clock phases, as previously described in connection with FIG. 1A. The switched-capacitor circuit 208 is operative to generate a regulated output signal, Vout, of the SCVR circuit 200. Together, the comparator 202, latch circuit 204, clock generator 206 and switched-capacitor circuit 208 form a closed-loop feedback control system operative to provide the regulated output voltage Vout. An overall loop delay 210 associated with SCVR circuit 200 (e.g., latch circuit 204, clock generator 206 and switched-capacitor circuit 208) will determine a maximum frequency of operation of the SCVR circuit.

Although depicted herein as being comprised of individual functional blocks, it is to be appreciated that two or more blocks in the SCVR circuit 200 may be combined into a single block which incorporates the functions of the combined blocks. For example, the latch function represented by latch circuit 204 may be combined with the comparator 202 to form a latching comparator which incorporates the latching function. Likewise, the functionality of latch circuit 204 may be integrated within the clock generator 206.

FIG. 3 is a schematic diagram depicting at least a portion of an exemplary clock generator circuit 300 which can be utilized in the SCVR circuit 200 shown in FIG. 2. The clock generator circuit 300 may be used to implement at least a portion of the clock generator 206, and also incorporates at least portions of the comparator 202 and latch circuit 204 shown in FIG. 2. More particularly, the clock generator circuit 300 includes a plurality of comparators, 302, 304 and 306, and a plurality of corresponding latches, implemented in this embodiment as D-type flip-flops 308, 310 and 312, respectively. Each comparator 302, 304, 306 is adapted to receive a reference signal, Vref, and an output signal, Vout, of the SCVR circuit, and to generate a comparator output signal as a result of a comparison between Vref and Vout. The output signal of each comparator is used to clock the corresponding latch. Additionally, the output of a given comparator is used as an enable signal, en, of a subsequent comparator.

Specifically, comparator 302 generates a first output signal which is used as a clock signal for latch 308 and as an enable signal for comparator 304. Comparator 304 generates a second output signal which is used as a clock signal for latch 310 and as an enable signal for comparator 306. The enable signal supplied to comparator 302 may be generated by the system in which the clock generator circuit 300 is used. Reset logic 314 included in the clock generator circuit 300 is operative to generate reset signals supplied to each of the comparators 302, 304, 306, which, in turn, will reset the latches 308, 310 and 312. An output signal generated by each latch 308, 310, 312 is indicative of a given clock phase P1, P2, P9, respectively. It is to be appreciated that embodiments of the invention are not limited to any specific number or degrees of separation of the clock phases.

In terms of operation, whenever the output voltage Vout supplied to the comparator 202 in the SCVR circuit 200 shown in FIG. 2 falls below the reference voltage Vref, the comparator triggers and generates a clock edge which is supplied to the switched-capacitor network (208), thereby causing the SCVR output Vout to rise above Vref. This occurs continuously to ensure that Vout is always above Vref. Thus, the regulated output Vout generated by the SCVR circuit 200 will exhibit a direct current (DC) value substantially equal to the reference voltage Vref and a ripple amplitude defined by multiphase interleaving, the capacitance value Cfly, and the switched-capacitor mode of operation. An exemplary ripple amount is about 30 millivolts (mV), although embodiments of the invention are limited to any specific ripple amount.

Internal bias circuitry used to generate the reference voltage (e.g., Vref) for controlling an output voltage of the regulator, as well as other functional circuitry (e.g., comparator) in the voltage regulator, are often powered directly from the regulated output voltage (i.e., self-powered). While improving the performance of voltage regulators and/or reducing wiring congestion, among other benefits, by generating the reference voltage from the regulated output voltage, this circuit configuration creates a scenario in which these functional circuits may not be self-starting when power is first applied to the voltage regulator or when the regulator output is momentarily shorted to ground. Consequently, many voltage regulators employ start-up circuitry to initiate and, when needed, maintain a flow of current in the regulator independent of output conditions. The start-up circuitry, however, undesirably increases power consumption in the voltage regulator and may also interfere with the normal operation of the regulator. Hence, the start-up circuitry should be turned off or otherwise disabled once the voltage regulator output has reached a stable and sustainable level. Furthermore, the start-up circuitry should be able to be turned on or otherwise enabled again whenever needed to assist in proper operation of the voltage regulator. Embodiments of the invention provide a dynamic start-up circuit which is operative to turn off once the voltage regulator output has reached a stable and sustainable level, and to turn on again whenever needed to assist in proper operation of the voltage regulator.

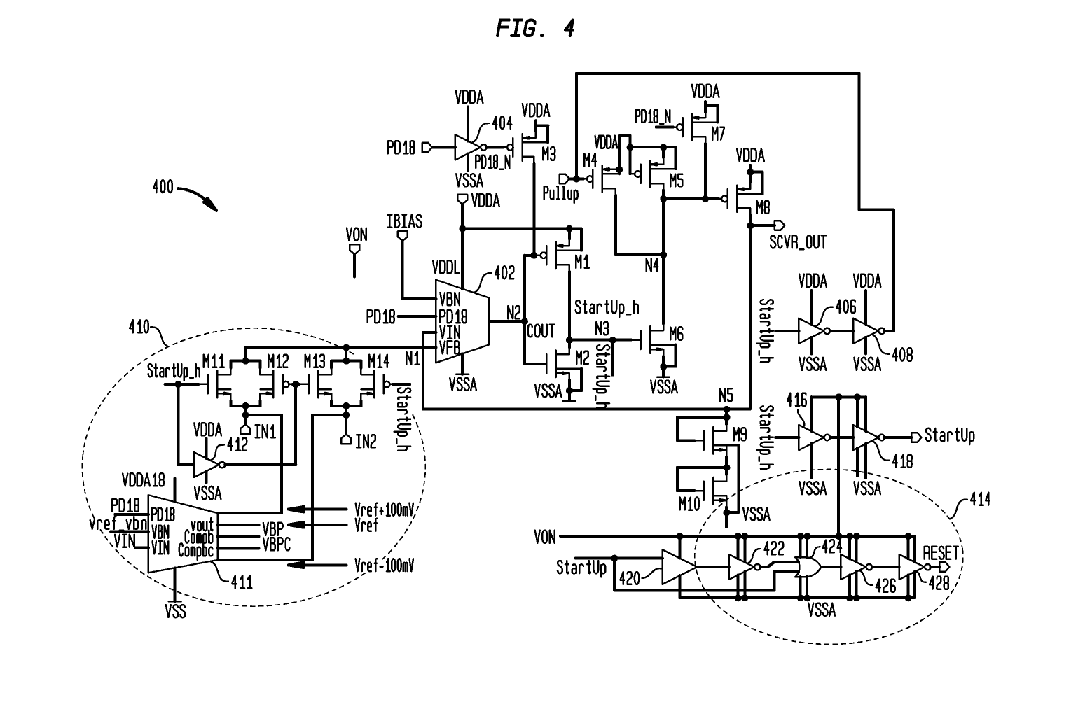

By way of example only and without limitation, FIG. 4 is a schematic diagram depicting at least a portion of an exemplary startup circuit 400 suitable for use in an SCVR circuit, according to an embodiment of the invention. The startup circuit 400 includes a first comparator 402 operative to generate an output signal, COUT, at node N2 which is indicative of a comparison between two input signals supplied thereto. The comparison output signal COUT is used to generate a startup control signal, StartUp_h, in the startup circuit 400.

Specifically, the output signal COUT of comparator 402 is supplied to an input of a first inverter comprised of a PMOS transistor, M1, and an NMOS transistor, M2, configured in a standard fashion. More particularly, a source of PMOS transistor M1 is adapted for connection with a first voltage supply, which in this embodiment is VDDA (e.g., about 1.8 volts), a drain of M1 is connected with a drain of NMOS transistor M2 at node N3 and forms an output of the first inverter for generating startup control signal StartUp_h, a source of M2 is adapted for connection with a second voltage supply, which in this embodiment is VSSA (e.g., zero volts or ground), and gates of M1 and M2 are connected with the output of the comparator 402 at node N2. Thus, the startup control signal StartUp_h will essentially be a logical inversion of the comparator output signal COUT under normal operation of the startup circuit 400.

It is to be appreciated that, because a metal-oxide-semiconductor (MOS) device is symmetrical in nature, and thus bi-directional, the assignment of source and drain designations in the MOS device is essentially arbitrary. Therefore, the source and drain of a given MOS device may be referred to herein generally as first and second source/drain, respectively, where “source/drain” in this context denotes a source or a drain.

The output of comparator 402 at node N2 is connected with a pull-up device, PMOS transistor M3. The pull-up device is operative to pull node N2 up to VDDA as a function of a power-down control signal, PD18, which may be, for example, a system power-down signal. More particularly, a source of PMOS transistor M3 is adapted for connection with VDDA and a drain of M3 is connected with the output of the comparator 402 at node N2. A gate of M3 is adapted to receive a logical inversion of the power-down control signal, PD18_N, which in this embodiment is generated by passing the power-down control signal PD18 through a second inverter 404. In one or more embodiments, the power-down control signal PD18 is supplied as an input to the comparator 402, which is used to selectively disable the comparator to reduce power consumption in the SCVR circuit 400, for example during a power-down mode of operation. In one or more embodiments, when the power-down control signal PD18 is active (e.g., logic high or “1” level), comparator 402 will be disabled; when the comparator 402 is disabled, the output of the comparator will be in an unknown state. However, transistor M3 will turn on when signal PD18 is active, thereby pulling node N2 up to VDDA so as to ensure that the state of the startup control signal StartUp_h is defined.

The startup control signal StartUp_h is used for controlling other circuitry in the startup circuit 400, as will be described in further detail herein below. The startup circuit 400 further comprises PMOS transistors, M4, M5, and M7, and an NMOS transistor, M6. A source of transistor M4 is adapted for connection with VDDA, and a gate of M4 is adapted to receive a pull-up control signal, Pullup, which is essentially a buffered version of the startup control signal StartUp_h. Signal Pullup, in this embodiment, is generated by passing the signal StartUp_h through a pair of standard inverters 406 and 408 connected in series. A drain of transistor M4 is connected with drains of transistors M5 and M6 at node N4. A source and gate of M5 are connected together and adapted for connection with VDDA, and source of M6 is adapted for connection with VSSA, and a gate of M6 is connected with node N3 and adapted to receive the startup control signal StartUp_h. Transistor M5, connected in this manner, is operative essentially as a capacitive element. PMOS transistor M7 is configured as a pull-up device, having a source adapted for connection with VDDA, a gate adapted to receive control signal PD18_N, which is a logical inversion of the power-down control signal PD 18 as previously stated, and a drain connected with the drains of M4, M5 and M6 at node N4. Thus, when the power-down control signal PD18 is active, M7 will turn on, thereby pulling node N4 up to VDDA.

Node N4 is connected with a bias circuit in an output stage in the startup circuit 400 comprising a PMOS transistor, M8, and a pair of NMOS transistors, M9 and M10, each NMOS device M9, M10 being connected in a series diode arrangement. More particularly, a source of PMOS transistor M8 is adapted for connection with VDDA, a gate of M8 is connected with node N4, and a drain of M8 is connected with a drain and a gate of NMOS transistor M9 at node N5, which forms an output of the startup circuit 400 for generating an output signal, SCVR_OUT. A source of M9 is connected with a drain and a gate of NMOS transistor M10, and a source of M10 is adapted for connection with VSSA. During a normal mode of operation, when the startup circuit 400 is disabled, the SCVR circuit is operative to regulate the output signal SCVR_OUT on its own, without the aid of the startup circuit. The output signal SCVR_OUT is fed back to a first input (VIN) of the comparator 402. This output signal SCVR_OUT is compared with a reference signal supplied to a second input (VFB) of the comparator 402.

The reference signal to which the output signal SCVR_OUT is compared is generated by a reference circuit 410 included in the startup circuit 400. The reference circuit 410 comprises an amplifier 411 operative to generate at least three output voltages, Vref−ΔV, Vref, and Vref+ΔV, as a function of an input reference signal, VIN, supplied to the reference circuit, where Vref and ΔV are prescribed voltages. The amplifier 411 is configured such that monotonicity between the output voltages Vref−ΔV, Vref, and Vref+ΔV is guaranteed. In this embodiment, Vref is about 0.8 volt and ΔV is about 100 mV, although embodiments of the invention are not limited to any specific voltages for Vref or ΔV. The difference between the output voltages Vref+ΔV and Vref−ΔV should be greater than or equal to an amplitude of a ripple component (i.e., ripple amplitude) of the regulated output voltage (Vref) of the SCVR circuit in which the startup circuit 400 is employed; in one or more embodiments, the ripple amplitude of the SCVR is about 30 mV.

Although in this embodiment, the upper threshold voltage Vref+ΔV and the lower threshold voltage Vref−ΔV are assumed to be symmetrical about Vref, such upper and lower threshold voltages need not be symmetrical about Vref. For example, in one or more embodiments, an upper threshold voltage is Vref+V1 and a lower threshold voltage is Vref−V2, where V1 and V2 are not necessarily equal. In this scenario, the sum of V1 and V2 is configured to be greater than or equal to the ripple amplitude of the SCVR.

The reference circuit 410 further includes a multiplexer for selecting a given one of the output voltages Vref+ΔV and Vref−ΔV generated by the amplifier 411 as a function of the startup control signal StartUp_h. In this embodiment, the multiplexer comprises a pair of transmission gates, although embodiments of the invention are not limited to any particular selection means. Specifically, a first transmission gate includes an NMOS transistor M11 and a PMOS transistor M12, and a second transmission gate includes an NMOS transistor M13 and a PMOS transistor M14. Drains of transistors M11, M12, M13 and M14 are connected together at node N1, which forms an output of the reference circuit 410 for generating the reference signal supplied to the second input (VFB) of the comparator 402. Sources of M11 and M12 are connected together at node IN1 and adapted to receive a first one of the output voltages Vref+ΔV generated by the amplifier 411. Sources of M13 and M14 are connected together at node IN2 and adapted to receive a second one of the output voltages Vref−ΔV generated by the amplifier 411. Gates of M11 and M14 are adapted to receive the startup control signal StartUp_h, and gates of M12 and M13 are adapted to receive a logical complement (i.e., inversion) of the startup control signal, which may be generated by passing the startup control signal StartUp_h through an inverter 412, or by alternative signal generation means. Thus, in this embodiment, when the startup control signal StartUp_h is a logic high level, transistors M11 and M12 will be turned on and transistors M13 and M14 will be turned off, thereby selecting the first one of the output voltages Vref+ΔV as the input signal to the comparator 402. Similarly, when the startup control signal StartUp_h is a logic low level, transistors M11 and M12 will be turned off and transistors M13 and M14 will be turned on, thereby selecting the second one of the output voltages Vref−ΔV as the input signal to the comparator 402.

The startup circuit 400 further comprises reset circuitry 414 operative to generate a reset control signal, RESET, as a function of a level-shifted version of the startup control signal StartUp_h. Specifically, the StartUp_h signal is passed through a pair of inverters, 416 and 418, connected in series to generate the RESET signal. Each of the inverters 416, 418 is powered by a third voltage supply, which in this embodiment is VON. This supply voltage VON is also used to power the reset circuitry 414. In one or more embodiments, VON is the regulated output voltage SCVR_OUT.

The reset circuitry 414 is adapted to receive, as an input thereof, a delayed version of the signal StartUp, which in this embodiment is generated by passing the StartUp signal through a delay block 420 having a prescribed delay associated therewith. By way of illustration only and without limitation, the reset circuitry 414 includes three inverters, 422, 426 and 428, and a logical OR gate 424; the delay block 420, or at least a portion thereof, may also be incorporated into the reset circuitry 414. An input of inverter 422 is connected an output of the delay block 420, an output of inverter 422 is connected with a first input of OR gate 424, and a second input of the OR gate is adapted to receive the signal StartUp. An output of the OR gate 424 is connected with an input of inverter 426, an output of inverter 426 is connected with an input of inverter 428, and an output of inverter 428 is operative to generate the RESET signal. This RESET signal is used, in one or more embodiments, to reset at least one circuit element in the SCVR circuit, such as, for example, comparators 302, 304 and 306 in the exemplary clock generator circuit 300 shown in FIG. 3.

It is to be appreciated that the logic gates used in the reset circuitry 414 are depicted as functional representations (i.e., abstractions), and that one or more logical gates may be added or removed, in accordance with embodiments of the invention, without affecting the function thereof. For example, an inverting delay block may be employed, which would eliminate the need for inverter 422. Similarly, an even number of inverters can be added between inverter 422 and OR gate 424, and a delay of the delay block 420 can be decreased by an amount equivalent to a corresponding delay of the added inverters to provide the same circuit function. Various other modifications to the reset circuitry 414 can be made, as will become apparent to those skilled in the art given the teachings herein.

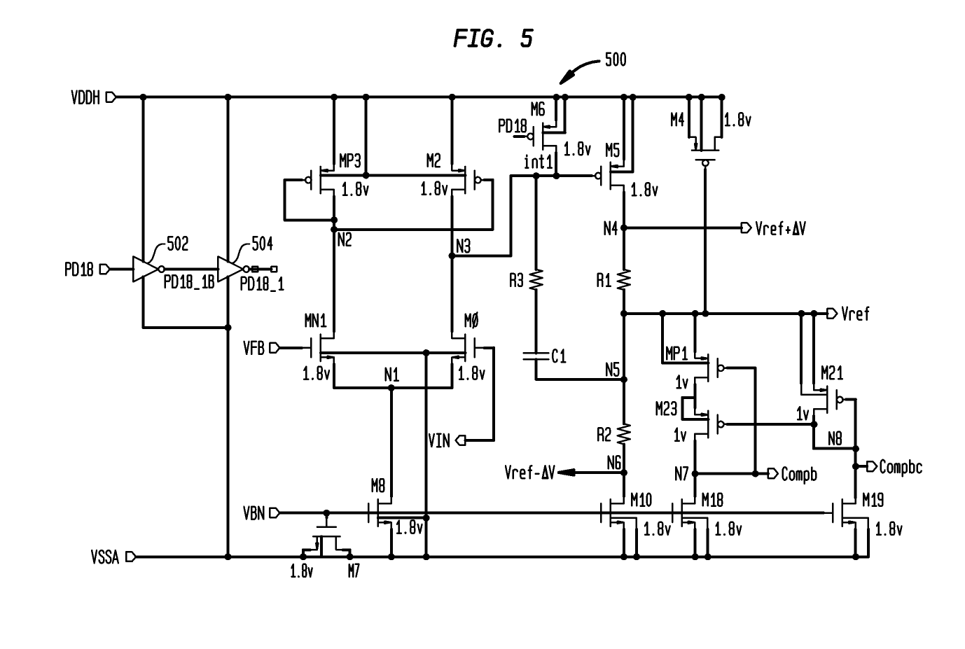

FIG. 5 is a schematic diagram depicting at least a portion of an exemplary amplifier circuit 500 suitable for use in the reference circuit 410 shown in FIG. 4, according to an embodiment of the invention. The amplifier circuit 500 includes a first (core) stage comprising a differential input stage connected with a differential load stage. The input stage comprises first and second NMOS transistors, M0 and MN1, respectively, connected in a common source configuration, and the differential load stage comprises first and second PMOS transistors, M2 and MP3, respectively, connected so as to form a current mirror. An NMOS bias transistor, M8, connected the input stage is operative to bias the amplifier at a prescribed quiescent operating point. Each of transistors M0, MN1, M2, MP3 and M8 is a high-voltage device (e.g., 1.8 volts).

More particularly, sources of MN1 and M0 are connected together at node N1, a gate of M0 forms a first input of the amplifier circuit 500 adapted to receive a first input signal (VIN) supplied to the amplifier circuit, a gate of MN1 forms a second input of the amplifier adapted to receive a second input signal (VFB) supplied to the amplifier circuit, a drain of MN1 is connected with a drain and gate of MP3 at node N2, and a drain of M0 is connected with a drain of M2 at node N3. A gate of M2 is connected with the gate of MP3 at node N2, and sources of MP3 and M2 are adapted for connection to a first voltage source, which in this embodiment is VDDH. A source of M8 is adapted for connection with a second voltage source, which in this embodiment is VSSA, a drain of M8 is connected with the input stage at node N1, and a gate of M8 is adapted to receive a bias signal, VBN, supplied to the amplifier circuit 500. An NMOS transistor, M7, is coupled with the gate of M8 and functions as a capacitive element for reducing noise in the bias signal VBN.

As will be understood by those skilled in the art, standard IC fabrication technologies generally provide at least two different types of transistors. Input/output (I/O) transistors are an example of a first type. I/O transistors are designed to operate in a relatively high-voltage environment, such as, for example, a 1.8-volt (V) nominal environment, and have a higher threshold voltage (e.g., about 0.7 volt) associated therewith compared to low-voltage transistors. In order to withstand the relatively high voltage without gate oxide breakdown, I/O transistors are formed having a relatively thick gate oxide, such as, for example, greater than about 50 angstroms thick and relatively long channel lengths (e.g., about twice the length of thin-oxide transistors). Therefore, the first type of transistor, which is able to withstand relatively high voltages and has relatively thick gate oxide, may be referred to herein as a “high-voltage” or “thick-oxide” transistor.

Alternatively, logic transistors are an exam of a second type of transistor provided in standard IC fabrication technologies. Logic transistors are designed to operate in a lower voltage environment, such as, for example, a 1.0-volt nominal environment, and have a lower threshold voltage (e.g., about 0.35 volt) associated therewith compared to high-voltage transistors. Because the voltages applied to these transistors are lower than the voltages applied to a thick-oxide transistor, the gate oxide of logic transistors does not need to be as thick compared to the gate oxide of a thick-oxide device. For example, the gate oxide thickness of a typical logic transistor may be only about 10 to 12 angstroms and the channel length short (e.g., at a minimum specified lithographic dimension). Therefore, the second type of transistor, which is able to withstand only relatively low voltages and has relatively thin gate oxide, may be referred to herein as a “low-voltage” or “thin-oxide” transistor.

The amplifier circuit 500 further includes a second (output) stage comprising a high-voltage (e.g., 1.8-volt) PMOS transistor, M5, and a high-voltage (e.g., 1.8-volt) NMOS transistor, M10, connected in a class-A configuration. Specifically, a source of transistor M5 is adapted for connection with VDDH, a gate of M5 is connected with the core stage at node N3, and a drain of M5 is connected with a first terminal of a first resistor, R1, at node N4 and forms a first output of the amplifier circuit 500 for generating a first output signal, Vref+ΔV. A second terminal of R1 is connected with a first terminal of a second resistor, R2, at node N5 and forms a second output of the amplifier circuit 500 for generating a second output signal, Vref. A second terminal of R2 is connected with a drain of transistor M10 at node N6 and forms a third output of the amplifier circuit 500 for generating a third output signal, Vref−ΔV, a gate of M10 is connected with the gate of M8, and a source of M10 is adapted for connection with VSSA. Resistors R1 and R2, connected in this manner, essentially form a voltage divider for generating three monotonic output voltages of the amplifier circuit 500.

In order to improve stability of the amplifier circuit 500, a compensation circuit is coupled between the second output of the amplifier circuit at node N5 and an output of the core stage at node N3. The compensation circuit, in this embodiment, comprises a resistor, R3, and a capacitor, C1, a first terminal of R3 being connected with node N3, a second terminal of R3 being connected with a first terminal of C1, and a second terminal of C1 being connected with node N5. It is to be appreciated that embodiments of the invention are not limited to any specific compensation circuit. Moreover, depending upon the application in which the amplifier circuit 500 is used and the type of load coupled with the amplifier circuit, compensation may not be required, at which point the compensation circuit can be eliminated from the amplifier circuit 500. In order to provide further stability, a capacitive element, which in this embodiment is implemented using a high-voltage (e.g., 1.8-volt) PMOS transistor, M4, is connected between the second output of the amplifier circuit 500 at node N5 and VDDH. More particularly, a drain and source of transistor M4 is connected with VDDH and a gate of M4 is connected with node N5. Various suitable compensation schemes may be employed, in accordance with embodiments of the invention.

The amplifier circuit 500 includes a bias circuit which is operative to generate one or more bias signals as a function of the output signal Vref generated by the amplifier circuit. These bias signals can be used, for example, for biasing a hysteretic comparator (e.g., comparator 202 shown in FIG. 2), which in turn is used to generate clock signals supplied to switches in the SCVR circuit (e.g., Sc_Unit 208 shown in FIG. 2). In this embodiment, the bias circuit comprises a low-voltage cascode current mirror (see, e.g., Pablo Aguirre et al., “Bias Circuit Design for Low-Voltage Cascode Transistors,” Proceedings of the 19^{th} Annual Symposium on Integrated Circuits and Systems Design SBCCI 06, pp. 94-98 (2006), the disclosure of which is incorporated by reference herein in its entirety), although embodiments of the invention are not limited to any particular bias circuit arrangement.

The bias circuit comprises low-voltage (e.g., 1.0-volt) PMOS transistors MP1, M23 and M21, and high-voltage NMOS transistors, M18 and M19. Specifically, sources of transistors MP1 and M21 are connected with the second output (Vref) of the amplifier circuit 500 at node N5, a drain of MP1 is connected with a source of transistor M23, and a gate of MP1 is connected with drains of transistors M23 and M18 at node N7 and forms a first bias output for generating a first bias signal, Compb. A gate and drain of transistor M21 is connected with a gate of transistor M23 and a drain of transistor M19 at node N8 and forms a second bias output for generating a second bias signal, Compbc, which is a cascode bias signal. Sources of transistors M18 and M19 are adapted for connection with VSSA.

In order to define the outputs of the amplifier circuit 500 during a power-down mode of operation, a pull-up circuit, which in this embodiment is implemented using a high-voltage PMOS transistor, M6, is connected between an output of the core stage at node N3 and VDDH. Specifically, a source of transistor M6 is adapted for connection with VDDH, a gate of M6 is adapted to receive a power-down signal, PD18_1B, and a drain of M6 is connected with node N3. The power-down signal PD18_1B, in this embodiment, is generated as a function of power-down control signal PD18 supplied to the amplifier circuit 500 by passing signal PD18 through a first inverter, 502. A buffered version of the power-down control signal PD18 can be generated by passing the power-down signal PD18_1B through a second inverter, 504, if required. Thus, when the power-down control signal PD18 is a logic high level indicative of a power-down mode of operation, the power-down signal PD18_1B will be a logic low level, thereby turning on transistor M6, pulling node N3 up to VDDH and turning off transistor M5 to disable the output stage in the amplifier circuit 500.

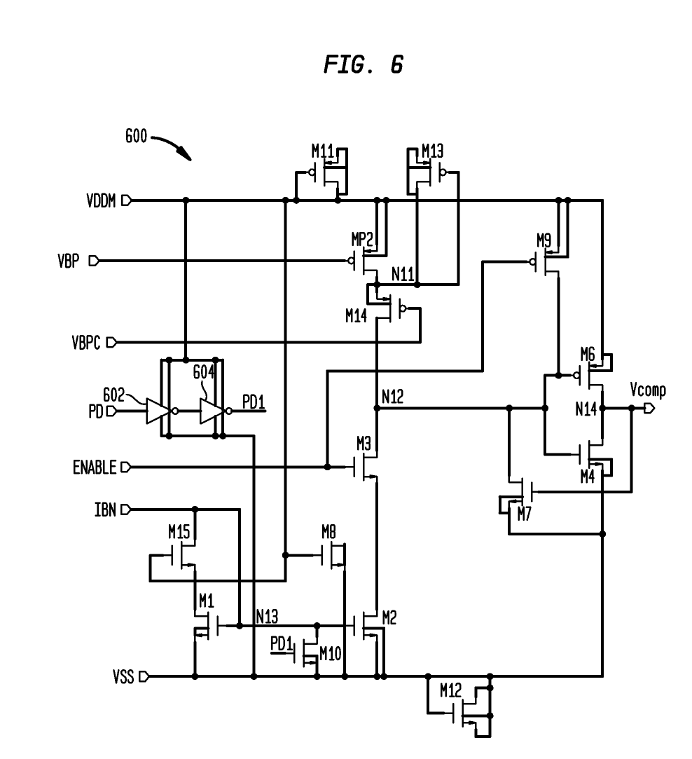

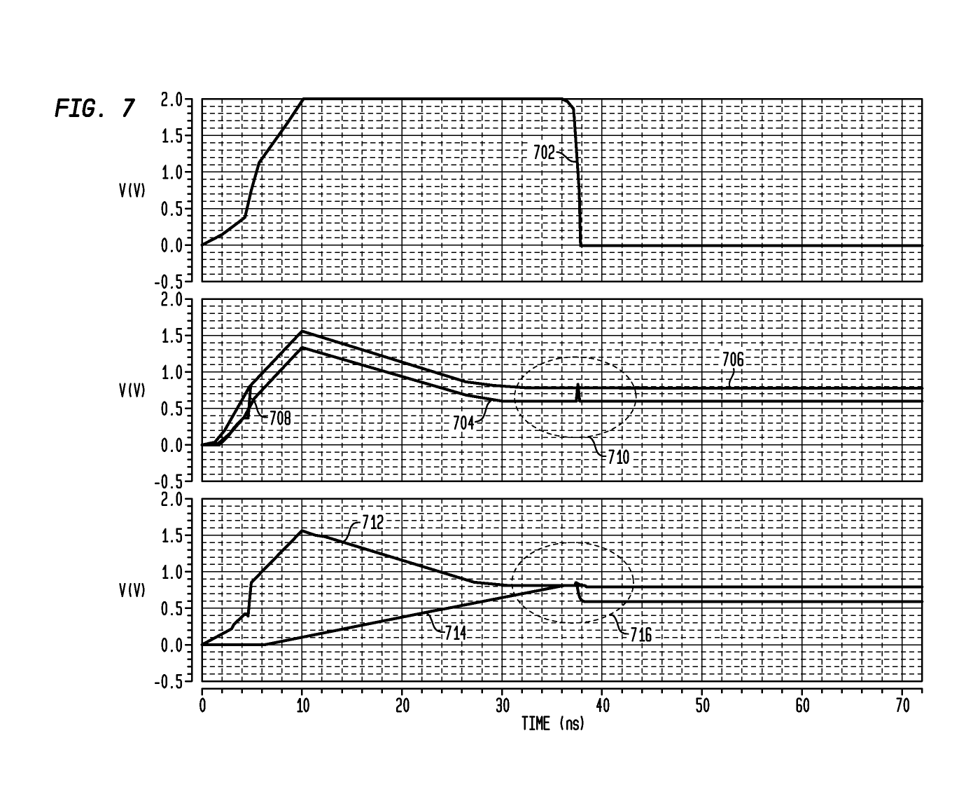

With reference now to FIG. 6, a schematic diagram depicts at least a portion of an exemplary hysteretic comparator 600 suitable for use in the illustrative SCVR circuit 200 shown in FIG. 2, according to an embodiment of the invention. It is to be appreciated that embodiments of the invention are not limited to the comparator architecture shown and described herein. The comparator 600 is powered by a voltage supply, VDDM, which in this embodiment is the same as, or indicative of, the output signal SCVR_OUT. Comparator 600 includes a first stage, which performs the primary comparison function, and a second stage, which is an output stage. The primary comparison function is performed by way of a current balancing scheme between two bias circuits; namely, a first bias circuit comprised of PMOS transistors MP2 and M14 connected in a cascode configuration, and a second bias circuit comprised of NMOS transistor M2 and its corresponding current mirror.

More particularly, transistors MP2 and M14 forming the first bias circuit are arranged such that a source of MP2 is adapted for connection with VDDM, a drain of MP2 is connected with a source of M14 at node N11, a gate of MP2 is adapted to receive a first bias signal, VBP, which in this embodiment is the cascode bias signal Compbc generated by the amplifier circuit 500 shown in FIG. 5, a gate of M14 is adapted to receive a second bias signal, which in this embodiment is the bias signal Compb generated by the amplifier circuit 500, and a drain of M14 forms an output of the first stage at node N12. Comparator 600 includes a PMOS transistor M13, which is a dummy transistor, having a gate, source and rain connected with node N11. Transistor M13, in this embodiment, is used primary for matching purposes. In one or more other embodiments, transistor M13 may be eliminated.

The second bias circuit comprises NMOS transistors M15, M1 and M2. A drain of transistor M15 and gates of transistors M1 and M2 are connected together at node N13 and adapted to receive a bias signal, IBN, supplied to the comparator 600, a gate of M15 is adapted for connection with VDDM, a source of M15 is connected with a drain of M1, and sources of M1 and M2 are adapted for connection with VSS. In this embodiment, IBN is a bias current generated externally and provided to the comparator 600. A drain of M2 is connected with the output of the first stage at node N12 via an NMOS enable transistor, M3. Specifically, a source of transistor M3 is connected with the drain of transistor M2, a drain of M3 is connected with node N12, and a gate of M3 is adapted to receive an enable signal, ENABLE, supplied to the comparator 600. Thus, when the enable signal is active high, transistor M3 is turned on and transistor M2 is connected with node N12. Likewise, when ENABLE is low, transistor M3 is turned off and therefore no current will flow through transistors MP2, M14, M3 and M2 forming the first comparator stage.

During a power-down mode of operation, node N13 may become undefined. Accordingly, in order to define node N13 during power-down, an NMOS transistor, M10, is connected between node N13 and VSS. A gate of transistor M10 is adapted to receive a power-down control signal, PD1, which in this embodiment is essentially a buffered version of a power-down signal, PD, supplied to the comparator 600, a source of M10 is adapted for connection with VSS, and a drain of M10 is connected with node N13. Thus, when control signal PD1 is active high during a power-down mode, transistor M10 is turned on thereby pulling node N13 to VSS to ensure that transistors M1 and M2 are turned off. Control signal PD 1 is generated in this embodiment by passing the power-down signal PD through a pair of series-connected inverters, 602 and 604. Alternative means for generating the power-down signal PD1 are similarly contemplated, as will become apparent to those skilled in the art given the teachings herein.

The second (output) stage in comparator 600, in this embodiment, comprises a PMOS transistor, M6, and an NMOS transistor, M4, configured as an inverter. Specifically, a source of transistor M6 is adapted for connection with VDDM, a drain of M6 is connected with a drain of transistor M4 at node N14 and forms an output of the comparator 600 for generating an output signal, Vcomp, a source of M4 is adapted for connection with VSS, and gates of M6 and M4 are connected with node N12. Thus, the output signal Vcomp will be a logical inversion of the voltage at node N12. The output stage further includes a pull-up device, such as PMOS transistor M9, having a source adapted for connection with VDDM, a gate adapted to receive the enable signal ENABLE, and a drain connected with node N12. When ENABLE is active high, transistor M9 is turned off and hence does not affect an operation of the output stage; when ENABLE is inactive low, M9 is turned on to ensure that transistor M6 is turned off.

In order to improve the speed of the comparison output and to provide latching capability, an NMOS transistor, M7, is included in the comparator 600. Transistor M7 is connected in a manner which provides positive feedback (i.e., as a latch) in the output stage of the comparator 600. More particularly, a drain of transistor M7 is connected with node N12, a source of M7 is connected with VSS, and a gate of M7 is connected with the output at node N14. Accordingly, as the output signal Vcomp starts to rise, transistor M7 turns on harder, thereby pulling down node N12 to VSS.

Comparator 600 optionally comprises one or more transistors configured as capacitive elements operative to reduce noise on the voltage supply and VSS connections. For example, comparator 600 includes a PMOS transistor, M11, having a source, gate and drain connected with VDDM. Likewise, an NMOS transistor, M12, having a source, gate and drain connected with VSS, is also included in the comparator 600.

In terms of circuit operation, with reference again to FIG. 4, during startup initialization, the output of comparator 402 will be low, and therefore the startup control signal StartUp_h will be at a logic high level; the power down control signal PD18 will be at a logic low level (i.e., inactive) at this point since the SCVR circuit is not in a power-down mode of operation during startup initialization. With the StartUp_h signal at a logic high level, transistors M11 and M12 in the reference circuit 410 will be turned on and transistors M13 and M14 will be turned off, and hence the second input (VFB) of the comparator 402 will be driven by the signal Vref+ΔV through transistors M11 and M12. The startup circuit 400 will cause the SCVR output signal SCVR_OUT at node N5 to slowly ramp up and reach a voltage level that is beyond Vref+ΔV. When the value of the signal SCVR_OUT at node N5 exceeds the value of the signal Vref+ΔV at node N1, the StartUp_h signal is driven to a logic low level, which causes the reset circuitry 414 to generate an output RESET pulse which resets an enable for each of the hysteretic comparators (e.g., comparators 302, 304 and 306 in FIG. 3) in the SCVR circuit. Concurrently, when the StartUp_h signal is driven low, transistors M11 and M12 in the reference circuit 410 will be turned off and transistors M13 and M14 will be turned on, and hence the second input (VFB) of the comparator 402 in the startup circuit 400 will be driven by the signal Vref−ΔV through transistors M13 and M14, thus dynamically changing the reference level to which the SCVR output signal SCVR_OUT is compared by the startup circuit 400.

With the StartUp_h signal at a logic low level, the Pullup signal, generated by passing the StartUp_h signal through inverters 406 and 408, will also be at a logic low level. The Pullup signal being at a low level will turn on transistor M4 in the startup circuit 400, thereby pulling up node N4 to VDDA (a logic high level) and ensuring that transistor M8 is turned off. This essentially disables the startup circuit 400 from further affecting the operation of the SCVR circuit until the output signal SCVR_OUT falls below Vref−ΔV, at which point the StartUp_h signal will again be driven to a logic high level dynamically enabling the startup circuit 400 for operation as previously described.

The SCVR circuit will startup and resume normal operation when at least one of the hysteretic comparators triggers (i.e., changes state) and generates a clock edge, which is supplied to the switched capacitor A cell (e.g., Sc_Unit 208 in FIG. 2). Once the clock edge is supplied to the SC cell, the switches therein will change state and the SCVR output signal SCVR_OUT will begin to slowly discharge. Since the hysteretic comparators in the SCVR circuit compare the output signal SCVR_OUT with the signal Vref generated by the reference circuit 410, rather than comparing SCVR_OUT with Vref±ΔV as in the startup circuit 400, as soon as SCVR_OUT falls below Vref, the hysteretic comparator triggers to thereby generate a clock pulse for the SC cell. Upon receiving the clock edge by the SC cell, the output SCVR_OUT will be boosted above Vref. In this manner, the SCVR output voltage SCVR_OUT is maintained around the value of Vref with some ripple component (e.g., about 30 mV). As previously stated, the startup circuit is designed such that a magnitude of the ripple component is less than ΔV.

FIG. 7 depicts exemplary waveforms for prescribed signals in the illustrative startup circuit 400 shown in FIG. 4, according to an embodiment of the invention. In a first (top) graph pane, waveform 702 is indicative of the startup control signal StartUp_h in the startup circuit 400 during an initial power-up period. In a second (middle) graph pane, waveform 704 is indicative of the reference signal Vref−ΔV and waveform 706 is indicative of the reference signal Vref+ΔV generated by the reference circuit 410 shown in FIG. 4. Waveform 708 shown in the second pane is indicative of the voltage at the second input (VFB) to comparator 402 at node N1. In a third graph pane, waveform 712 is again indicative of the voltage at the second input to comparator 402 at node N1, and waveform 714 is indicative of the output voltage SCVR_OUT of the SCVR circuit.

As apparent from FIG. 7, once the StartUp_h signal (waveform 702) exceeds a prescribed voltage (e.g., an NMOS or PMOS threshold voltage) indicative of a logic high level, the voltage at node N1 (waveform 708) follows Vref+ΔV (waveform 706). This is state is maintained for the duration of the StartUp_h signal (waveform 702) being a logic high level; from time 0 to about 37 ns. During this period, the output voltage SCVR_OUT (waveform 714) slowly ramps up from zero volts until it eventually exceeds Vref+ΔV (at about time 37.5 ns). Once SCVR_OUT exceeds Vref+ΔV, shown in the third graph pane as area 716, the StartUp_h signal switches state and is driven low, at which point the voltage at node N1 dynamically switches from being driven by Vref+ΔV to being driven by Vref−ΔV. This switchover point is shown as area 710 in the second graph pane. Concurrently, the output voltage SCVR_OUT maintains a level of about Vref, after about time 38 ns, thereby keeping the startup circuit disabled, as evidenced by the low state of the startup control signal StartUp_h 702. In order for the startup circuit to be enabled again, the SCVR output voltage SCVR_OUT must fall to below Vref−ΔV. In this example, ΔV is about 100 mV, although embodiments of the invention are not limited to any particular value for ΔV.

It is to be appreciated that reducing the value of Vref during startup initialization will address reliability concerns, since SCVR_OUT will be ramped up to beyond Vref+ΔV. Assuming ΔV is equal to about 100 mV, a core (i.e., thin-oxide) device with Vref+100 mV between any two of its terminals will raise reliability issues. If, however, Vref is reduced by more than about 100 mV during startup, the lifespan of the device is increased accordingly. More particularly, for thin-oxide transistors, a voltage difference between any two terminals of the device beyond a prescribed maximum operating voltage may pose a reliability concern. VREF is a DC level and the SCVR generates an output voltage VOUT which has a DC level equal to VREF. However, using the startup circuit according to one or more embodiments of the invention, the SCVR output VOUT is driven to more than VREF+100 mV, which could present a reliability issue. Consequently, until the startup operation is completed, VREF is configured, according to one or more embodiments, to be less than its prescribed nominal value so as to ensure that repeated startup operations do not reduce a lifespan of circuit components (e.g., transistors) due to the output being driven to a level above VREF+100 mV.

At least a portion of the embodiments of the invention may be implemented in an integrated circuit. In forming integrated circuits, identical die are typically fabricated in a repeated pattern on a surface of a semiconductor wafer. Each die includes a device described herein, and may include other structures and/or circuits. The individual die are cut or diced from the wafer, then packaged as an integrated circuit. One skilled in the art would know how to dice wafers and package die to produce integrated circuits. Integrated circuits so manufactured are considered part of this invention.

An integrated circuit in accordance with embodiments of the invention can be employed in essentially any application and/or electronic system in which voltage regulation and/or voltage scaling is used. Suitable applications and systems for implementing techniques according to embodiments of the invention may include, but are not limited to, clock and data recovery (CDR) circuitry, reference voltage generators, phase-locked loop (PLL) circuitry, timing circuitry, electrostatic discharge (ESD) protection, input/output (I/O) buffers, serializer/deserializer (SERDES) devices, etc. Systems incorporating such integrated circuits are considered part of embodiments of the invention. Given the teachings of embodiments of the invention provided herein, one of ordinary skill in the art will be able to contemplate other implementations and applications of the techniques of embodiments of the invention.

The embodiments of the invention described herein are intended to provide a general understanding of the various embodiments, and are not intended to serve as a complete description of all the elements and features of apparatus and systems that might make use of the structures described herein. Other embodiments will become apparent to those skilled in the art given the teachings herein; other embodiments are utilized and derived therefrom, such that structural and logical substitutions and changes can be made without departing from the scope of this disclosure. The drawings are also merely representational and are not necessarily drawn to scale. Accordingly, the specification and drawings are to be regarded in an illustrative rather than a restrictive sense.

Embodiments of the invention are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The abstract is provided to comply with 37 C.F.R. §1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, inventive subject matter lies in less than all features of a single embodiment. Thus the following claims are hereby incorporated into the Detailed Description, with each claim standing on its own as separately claimed subject matter.

Given the teachings of embodiments of the invention provided herein, one of ordinary skill in the art will be able to contemplate other embodiments of the invention. Although embodiments of the invention have been described herein with reference to the accompanying drawings, it is to be understood that embodiments of the invention are not limited to the described embodiments, and that various other embodiments within the scope of the following claims will be apparent to those skilled in the art given the teachings herein.

What is claimed is:

1. A startup circuit for use with a switched-capacitor voltage regulator circuit, the startup circuit comprising:
a comparator operative to generate a first control signal as a function of a comparison between an output voltage generated by the switched-capacitor voltage regulator circuit and a reference voltage, the first control signal being used to disable the startup circuit;
a reference generator coupled with the comparator and operative to generate at least first, second and third voltages, the second voltage being greater than the first voltage and the third voltage being greater than the second voltage; and
a controller coupled with the reference generator and operative to dynamically select a given one of the first and third voltages as the reference voltage supplied to the comparator as a function of the first control signal.

2. The startup circuit of claim 1, further comprising a bias circuit adapted for connection with an output of the switched-capacitor voltage regulator circuit, the bias circuit being operative to increase the output voltage generated by the switched-capacitor voltage regulator circuit during a first mode of operation of the startup circuit, the bias circuit being disabled during a second mode of operation of the startup circuit, the mode of operation of the startup circuit being controlled as a function of the first control signal.

3. The startup circuit of claim 2, wherein the bias circuit comprises:
at least a first PMOS transistor having a first source/drain adapted for connection with a voltage supply of the startup circuit, a gate adapted to receive a bias signal which is a function of the first control signal, and a second source/drain adapted for connection with the output of the switched-capacitor voltage regulator circuit;
at least first and second NMOS transistors, a gate and first source/drain of the first NMOS transistor being adapted for connection with the output of the switched-capacitor voltage regulator circuit, a second source/drain of the first NMOS transistor being connected with a gate and first source/drain of the second NMOS transistor, and a second source/drain of the second NMOS transistor being adapted for connection with a voltage return of the startup circuit.

4. The startup circuit of claim 3, wherein the bias circuit further comprises a power-down circuit coupled with the gate of the first PMOS transistor, the power-down circuit being adapted to receive a power-down signal and to disable the bias circuit as a function of the power-down signal.

5. The startup circuit of claim 1, wherein the controller comprises a multiplexer adapted to receive the first and third voltages generated by the reference circuit and to generate the reference voltage supplied to the comparator as a function of the first control signal.

6. The startup circuit of claim 1, further comprising reset circuitry operative to generate a reset control signal as a function of a level-shifted version of the first control signal, the reset control signal being operative to initialize at least one circuit element in the switched-capacitor voltage regulator circuit.

7. The startup circuit of claim 6, wherein the reset circuitry comprises a delay element having a prescribed delay associated therewith, the delay element being adapted to receive the first control signal and being operative to generate a delayed version of the first control signal, the reset circuitry being operative to generate the reset control signal as a function of the first control signal and the delayed version of the first control signal.

8. The startup circuit of claim 1, further comprising a power-down circuit coupled with an output of the comparator, the power-down circuit being adapted to receive a power-down signal and to disable the startup circuit as a function of the power-down signal.

9. The startup circuit of claim 1, wherein a magnitude of a difference between the first and third voltages is configured to be greater than or equal to an amplitude of a ripple component in the output voltage generated by the switched-capacitor voltage regulator circuit.

10. The startup circuit of claim 1, wherein at least a portion of the startup circuit is fabricated in at least one integrated circuit.

11. A switched-capacitor voltage regulator circuit, comprising:
at least a first comparator operative to receive a first input signal indicative of a regulated output signal of the voltage regulator circuit and a second input signal indicative of a first reference signal and to generate an output signal indicative of a comparison result between the first and second input signals;
a clock generator operative to receive the output signal generated by the first comparator and to generate a plurality of clock signals;
a switched-capacitor circuit operative to receive the plurality of clock signals and to generate, at an output of the switched-capacitor voltage regulator circuit, the regulated output signal as a function of the plurality of clock signals; and
a startup circuit coupled with at least one node in the voltage regulator circuit and operative to maintain a flow of current in the voltage regulator circuit, the startup circuit comprising:
a second comparator operative to generate a first control signal as a function of a comparison between the regulated output signal and a second reference signal, the first control signal being used to disable the startup circuit;
a reference generator coupled with the second comparator and operative to generate at least first, second and third voltages, the second voltage being greater than the first voltage and the third voltage being greater than the second voltage; and
a controller coupled with the reference generator and operative to dynamically select a given one of the first and third voltages as the second reference signal supplied to the second comparator as a function of the first control signal.

12. The switched-capacitor voltage regulator circuit of claim 11, further comprising a latch circuit coupled the first comparator and operative to hold the output signal indicative of the comparison result between the first and second input signals for a prescribed period of time.

13. The switched-capacitor voltage regulator circuit of claim 11, wherein the startup circuit further comprises a bias circuit adapted for connection with the output of the switched-capacitor voltage regulator circuit, the bias circuit being operative to increase the output voltage generated by the switched-capacitor voltage regulator circuit during a first mode of operation of the startup circuit, the bias circuit being disabled during a second mode of operation of the startup circuit, the mode of operation of the startup circuit being controlled as a function of the first control signal.

14. The switched-capacitor voltage regulator circuit of claim 13, wherein the bias circuit comprises:
at least a first PMOS transistor having a first source/drain adapted for connection with a voltage supply of the startup circuit, a gate adapted to receive a bias signal which is a function of the first control signal, and a second source/drain adapted for connection with the output of the switched-capacitor voltage regulator circuit;
at least first and second NMOS transistors, a gate and first source/drain of the first NMOS transistor being adapted for connection with the output of the switched-capacitor voltage regulator circuit, a second source/drain of the first NMOS transistor being connected with a gate and first source/drain of the second NMOS transistor, and a second source/drain of the second NMOS transistor being adapted for connection with a voltage return of the switched-capacitor voltage regulator circuit.

15. The switched-capacitor voltage regulator circuit of claim 14, wherein the bias circuit further comprises a power-down circuit coupled with the gate of the first PMOS transistor, the power-down circuit being adapted to receive a power-down signal and to disable the bias circuit as a function of the power-down signal.

16. The switched-capacitor voltage regulator circuit of claim 11, wherein the controller comprises a multiplexer adapted to receive the first and third voltages generated by the reference circuit and to generate the second reference voltage supplied to the second comparator as a function of the first control signal.

17. The switched-capacitor voltage regulator circuit of claim 11, further comprising reset circuitry operative to generate a reset control signal as a function of a level-shifted version of the first control signal, the reset control signal being operative to initialize at least one circuit element in the switched-capacitor voltage regulator circuit.

18. The switched-capacitor voltage regulator circuit of claim 17, wherein the reset circuitry comprises a delay element having a prescribed delay associated therewith, the delay element being adapted to receive the first control signal and being operative to generate a delayed version of the first control signal, the reset circuitry being operative to generate the reset control signal as a function of the first control signal and the delayed version of the first control signal.

19. The switched-capacitor voltage regulator circuit of claim 11, further comprising a power-down circuit coupled with an output of the second comparator, the power-down circuit being adapted to receive a power-down signal and to disable the startup circuit as a function of the power-down signal.

20. An electronic system, comprising:
at least one integrated circuit including at least one switched-capacitor voltage regulator circuit, the at least one switched-capacitor voltage regulator circuit comprising:
at least a first comparator operative to receive a first input signal indicative of a regulated output signal of the voltage regulator circuit and a second input signal indicative of a first reference signal and to generate an output signal indicative of a comparison result between the first and second input signals;
a clock generator operative to receive the output signal generated by the first comparator and to generate a plurality of clock signals;
a switched-capacitor circuit operative to receive the plurality of clock signals and to generate, at an output of the switched-capacitor voltage regulator circuit, the regulated output signal as a function of the plurality of clock signals; and
a startup circuit coupled with at least one node in the voltage regulator circuit and operative to maintain a flow of current in the voltage regulator circuit, the startup circuit comprising:
a second comparator operative to generate a first control signal as a function of a comparison between the regulated output signal and a second reference signal, the first control signal being used to disable the startup circuit;
a reference generator coupled with the second comparator and operative to generate at least first, second and third voltages, the second voltage being greater than the first voltage and the third voltage being greater than the second voltage; and
a controller coupled with the reference generator and operative to dynamically select a given one of the first and third voltages as the second reference signal supplied to the second comparator as a function of the first control signal.
